(19) United States
(12) Patent Application Publication
(10) Pub. No.: US 2010/0004998 A1
(43) Pub. Date: Jan. 7, 2010

(54) Apparatus Pertaining to Identifying Information, Corresponding Characterizing Information, and Corresponding Modification of a Presentation that is Commonly Shared by a Plurality of End Users, and a Corresponding Method

(75) Inventors: Gregory J. Nawrocki, Winfield, IL (US); David J. Nugent, Winfield, IL (US)

Correspondence Address: FITCH EVEN TABIN & FLANNERY, 120 SOUTH LASALLE STREET, SUITE 1600, CHICAGO, IL, 60603-3406, US

(73) Assignee: MARKET REASON, LLC, Winfield, IL (US)

(21) Appl. No.: 12/495,014

(22) Filed: Jun. 30, 2009

Related U.S. Application Data
(60) Provisional application No. 61/078,071, filed on Jul. 3, 2008.

(51) Int. Cl. G06Q 30/00; G06F 15/16; G06F 17/30; G06F 7/06

(52) U.S. Cl. 705/14.67; 709/206; 705/14.66; 707/3; 707/E17.014

(57) ABSTRACT

A control circuit serves to receive data messages in conjunction with a corresponding source identifier from each of a plurality of sources (wherein the plurality of sources each have, at the time of sourcing their respective data message, a corresponding end user who is presently sharing a common presentation with others of the end users). The control circuit uses the source identifier to determine additional identifying information for at least a substantial number of these end users and then uses that additional identifying information to determine characterizing information for at least a substantial number of the end users. This characterizing information can then be used to modify the common presentation (for example, by controlling particular items of promotional content that comprise a part of the presentation).

### RELATED APPLICATION(S)

This application claims the benefit of U.S. Provisional Application No. 61/078,071, filed Jul. 3, 2008, which is incorporated by reference in its entirety herein.

### TECHNICAL FIELD

This invention relates generally to presentations that are shared by a plurality of end users and more particularly to modifications of such presentations.

### BACKGROUND

Presentations that are commonly experienced by a plurality of end users are known in the art. The substantive content of such presentations can vary greatly but often relates, at least in part, to entertainment. Sporting events of various kinds are good examples in this regard and include football games, baseball games, basketball games, hockey games, and numerous other so-called spectator sports. In some cases the presentation is commonly shared amongst a plurality of end users who are physically present at the presentation venue (such as a sports stadium, auditorium, arena, or the like). In other cases, the presentation is commonly shared amongst a plurality of end users who each receive a broadcast (such as a television or radio broadcast) of the presentation.

In some cases the presentation includes promotional content advertising various products and services. Various concerned parties (including but not limited to the advertiser, the presentation sponsor, and even the end users themselves) desire that such promotional content be relevant and of interest to the end users. Course demographics often serve to provide information in these regards and inform the selection and pricing of such promotional content. Generally speaking, these demographics are “coarse” in that the information is often quite unspecific with respect to the individual constituent members of a given presentation audience. Furthermore, such demographic information is often significantly removed in time from a specific here-and-now audience. That is, such information often reflects only previous audiences as versus a present audience.

As a result, promotional content selection and pricing to be included as part of a common presentation is often only generally and roughly based upon past observations of prior audiences. This can lead to inefficiencies, mismatches between the content and the audience, under and over-pricing, bored, distracted, or annoyed end users, and other problems.

### BRIEF DESCRIPTION OF THE DRAWINGS

The above needs are at least partially met through provision of the apparatus pertaining to identifying information, corresponding characterizing information, and corresponding modification of a presentation that is commonly shared by a plurality of end users, and a corresponding method described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a control circuit serves to receive data messages in conjunction with a corresponding source identifier from each of a plurality of sources (wherein the plurality of sources each have, at the time of sourcing their respective data message, a corresponding end user who is presently sharing a common presentation with others of the end users). The control circuit uses the source identifier to determine additional identifying information for at least a substantial number of these end users and then uses that additional identifying information to determine characterizing information for at least a substantial number of the end users. This characterizing information can then be used to modify the common presentation (for example, by controlling particular items of promotional content that comprise a part of the presentation).

By one approach, the data message can comprise a Short Message Service data message that is sent in conjunction with a corresponding source identifier such as the ten digit telephone number as is presently assigned in the United States to the corresponding source. In such a case, and again by way of example, the additional identifying information can comprise information gleaned from a reverse-directory lookup database in response to a query based upon that telephone number. The characterizing information can then comprise information that is based upon further database queries using that additional identifying information.

By one approach, this characterizing information can comprise demographic information regarding the end user. As another example in these regards, this characterizing information can comprise psychographic information regarding the end user.

If desired, these teachings can include prompting the end users who share a common presentation to each transmit the aforementioned data message. By one approach, for example, this can comprise presenting, as a part of the presentation, an instruction to the end users to transmit the data message using their cellular telephones. Such an instruction can include, if desired, an incentive to motivate the end users to transmit the data messages.

These teachings afford a convenient and efficient mechanism to quickly and reliably develop characterizing information for at least a sizeable segment of a presentation audience. This view can be readily formed in near real-time and this, in turn, permits the information to be employed during the course of the presentation itself. The data-gathering process itself can be highly transparent and non-invasive to the end user. Those skilled in the art will appreciate that these teachings are highly scalable and can be successfully employed with an audience of tens or even hundreds of thousands of participants. It will further be appreciated that these teachings are readily employed in conjunction with numerous existing platforms, techniques, and methodologies and hence are highly leveragable as well.

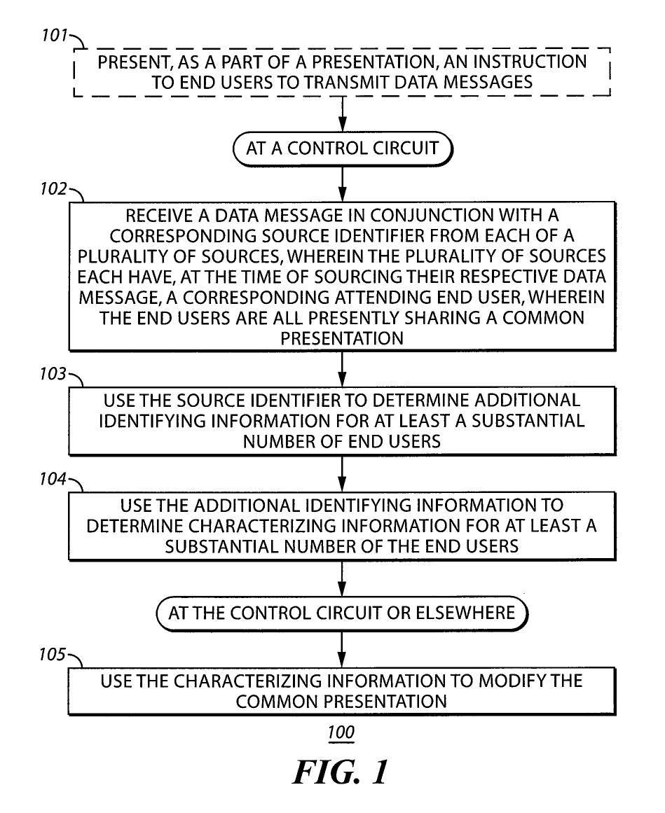

These and other benefits may become clearer upon making a thorough review and study of the following detailed description. Referring now to the drawings, and in particular to FIG. 1, an illustrative process 100 that is compatible with many of these teachings will now be presented.

This process 100 can be carried out with respect to a plurality of end users who are all experiencing, at the same time, a given presentation. This can comprise, for example, a presentation at a presentation venue (such as an arena, theater, park, stadium, or the like) at which the end users are physically present. This can also comprise, in lieu of the foregoing or in combination therewith, a broadcast presentation that some (or all) of the end users are each receiving. It will be noted that, in many instances, the presentation will be bounded by a start time and a stop time. Generally speaking, these teachings are implementable within such a time frame.

This process 100 can include, if desired, the optional step 101 of presenting, as a part of such a presentation, an instruction to the end users to transmit a particular data message. This instruction can include (either integrally or in a distributed fashion) an incentive to motivate the end users to transmit such a data message. In a sports stadium or arena, for example, this can comprise presenting such instructions using one or more video displays or in a printed handout. In a video broadcast application setting, this can comprise, for example, providing the instructions as a so-called crawl at the bottom of the end-user's display. Those skilled in the art will recognize and understand that the specifics of these examples serve an illustrative purpose only and are not offered with any suggestion or intent that these specifics comprise an exhaustive listing of all such possibilities in this regard.

The aforementioned incentive can vary as desired. By one approach, this incentive can comprise the opportunity to vote or otherwise voice one's opinion favorably or disfavorably with respect to some identified subject. By another approach, this incentive can comprise receiving some physical or virtual consideration such as, but not limited to, a code, token, or coupon that will garner a discount at a local concession stand. Numerous other possibilities exist in these same regards. For example, the incentive can comprise entering the end user into a contest, promotion, or sweepstakes for some prize.

With continued reference to FIG. 1, the remaining steps of this process 100 can be carried out, as desired, by a control circuit. Further elaboration regarding this control circuit will be provided below where appropriate.

At step 102, this process 100 provides for receiving a data message (such as the aforementioned end-user data message) in conjunction with a corresponding source identifier from each of a plurality of sources. Each of these sources, in turn, has, at the time of sourcing their respective data message, a corresponding attending end user. As used herein, this reference to “attending” will be understood to indicate that the end user is actively interacting with and otherwise using the source. When the source comprises, for example, a cellular telephone or the like, the end user “attends” the cellular telephone by entering or selecting a particular communication destination and causing the cellular telephone to transmit a message to that destination. (It will be understood that the end users referred to in this step 102 comprise end users who are all sharing a common presentation as described above.)

The specific nature of this data message will of course vary with the specifics of the application setting. As one useful example in these regards, these data messages can comprise Short Message Service (SMS) data messages. Such SMS messages are typically set in conjunction with a corresponding source identifier—a ten digit telephone number as is presently assigned to the sourcing cellular telephone. (Those skilled in the art will recognize that SMS is often associated with the Global System for Mobile communications (GSM) standard(s) and provides a specific mechanism to support the transmission and reception of short text messages. There are other ways by which brief text messages are transmitted and received in a given wireless communication system and it will therefore be understand that this example is intended to serve only in an illustrative capacity and is not intended to comprise an exhaustive listing of all possibilities in this regard.)

At step 103 this process 100 provides for using the aforementioned source identifier to determine additional identifying information for at least a substantial number of the end users who transmitted the data message. When the source identifier comprises, for example, a telephone number, this step can comprise using that telephone number to query a so-called reverse-directory lookup database. Such databases are known in the art and serve to provide customer information such as the name of the person, their street address, and so forth. Access to such a resource can rely upon Internet-based access in many cases and as will be well understood by those skilled in the art. It will also be understood that such a query can be initiated and completed very rapidly. Using presently available platforms and protocols, for example, such query can be completed within five seconds or less.

It may not be possible, of course, to obtain additional identifying information for each and every one of the end users. Some end users, for example, may use a device having the equivalent of an unpublished number. As noted, however, one can usually expect to receive additional identifying information for at least a substantial number of such a gathering of persons. For example, at least some additional information should be available for at least a statistically-significant sample size of the plurality of end users. Statistical relevance, of course, comprises its own well-understood area of endeavor and requires no further elaboration here.

Generally speaking, these teachings contemplate effecting this step 103 of using the source identifiers to determine the additional identifying information within a few seconds of time following the step 102 of receiving those source identifiers. Generally speaking, both of these steps 102 and 103 are accomplished during the aforementioned presentation in order to provide the additional identifying information before the presentation concludes.

At step 104 this process 100 then provides for using the additional identifying information to determine characterizing information for at least a substantial number of the end users. Generally speaking, for many application settings, this characterizing information reveals such characteristics as consuming inclinations or habits, political inclinations, and so forth. This characterizing information can specifically comprise, for example, one or more categories of demographic information such as age, gender, race, geographic location(s), cultural affiliations, family status, societal or economic status or standing, educational or professional attainments, annual income or disposable income statistics, and so forth.

Depending upon the application setting, and in combination with the above or in lieu thereof, this characterizing information can specifically comprise, for example, one or more categories of psychographic information. Those skilled in the art will recognize that psychographic variables are any attributes relating to personality, values, attitudes, interests, lifestyles, and so forth.

As used herein, this reference to a substantial number of end users shall be understood to refer to at least thirty percent of the responding end users. Other thresholds can of course apply depending upon the needs and/or opportunities as tend to characterize a given application setting. For example, in some settings, as few as ten percent may be sufficient while in other cases it may be required that a great percentage (such as seventy-five, eighty, or ninety percent) be achieved.

Again, those skilled in the art will recognize and appreciate that this characterizing information can be gleaned in a relatively short period of time. For example, using modern data networking capabilities, such information for ten thousand end users can often be developed in less than one hour (and, given appropriate hardware and bandwidth, can be accomplished in even considerably less time). Accordingly, for a relatively large audience as one might find in a football stadium, thirty thousand audience members might respond to a properly incentivized invitation to source the aforementioned data message and the desired characterizing information for a majority of these respondents subsequently developed within the duration of the presentation. This, in turn, assures that the characterizing information is available during the course of the presentation itself.

Whether via the aforementioned control circuit or via some other instrumentality(ies), by step 105 this process 100 then provides for using this characterizing information to modify the common presentation. By one approach, this can comprise modifying at least a portion of the substantive presentation itself as a function of the characterizing information. Specifics in this regard will of course vary with the application setting and the characterizing information. As one example, this might comprise emphasizing attention and coverage being paid to a particular team or to a particular athlete during the presentation. As another example, this might comprise providing more, or less, commentary pertaining to the rules and regulations of the presented sport. Those skilled in the art will recognize that other possibilities exist in this regard as well with yet others likely to be developed going forward.

By another approach, this step 105 can comprise modifying the presentation by selecting at least one item of promotional content (from, for example, a plurality of candidate items of promotional content) as a function, at least in part, of the characterizing information. For example, a given potential advertiser may have agreed to have an advertisement for their particular product/service appear on the large video display(s) of a given sporting stadium if and when the characterizing information met certain predetermined threshold requirements as set by that potential advertiser. As another example, the duration of a particular promotional display might be determined, in whole or in part, as a function of the content of the characterizing information. Again, numerous other possibilities exist in these regards.

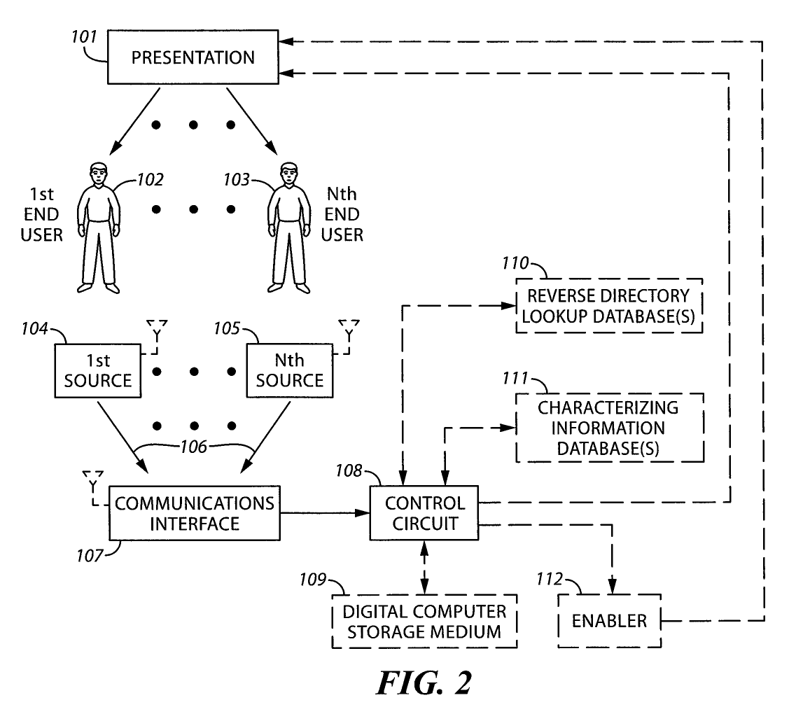

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

This apparatus presumes the existence of a presentation 101 and that a plurality of end users (represented here by a first end user 102 through an Nth end user 103 (where “N” will be understood to comprise an integer greater than one)) are experientially sharing that presentation 101. This apparatus also presumes that at least some of these end users each have a corresponding source (represented here by a first source 104 through an Nth source 105, presuming for the sake of illustration and simplicity that each of the end users has a corresponding source) such as a cellular telephone capable of SMS functionality.

When these sources 104,105 source a corresponding data message 106 as described above (such as an SMS text message), a communications interface 107 as comprises a part of this apparatus ultimately receives those data messages 106. By one approach, if desired, this communications interface 107 will directly receive such messages as when the communications interface 107 directly receives the transmissions of the sources. Such might be the case, for example, when the sources utilize an 802.11-compatible Wi-Fi transmission capability and the communications interface 107 is configured to directly compatibly receive such transmissions.

Perhaps more typically, however, this communications interface 107 will interface to one or more intervening networks (such as a wide-area cellular telephony network (not shown)) that serve to directly receive the aforementioned transmissions 106 and to convey the corresponding data messages to the communications interface 107. Various approaches are known in the art in these regards. As these teachings are not overly sensitive to any particular selection in this regard, for the sake of brevity and the preservation of clarity, further elaboration in this regard will not be presented here.

This communications interface 107 operably couples to a control circuit 108. Those skilled in the art will recognize and appreciate that such a control circuit 108 can comprise a fixed-purpose hard-wired platform or can comprise a partially or wholly programmable platform. All of these architectural options are well known and understood in the art and require no further description here.

In the case where the control circuit 108 comprises, in whole or in part, a programmable platform such as a digital computer, the control circuit 108 itself can comprise (partially or wholly) or may couple to a digital computer storage medium 109 of choice. This storage medium 109 can serve to store computer instructions which, when executed by a digital computer, will permit the digital computer to carry out one or more of the steps, actions, or functions described herein. Programming in general comprises a well known area of endeavor and accordingly no further details in those regards will be provided here. It will also be understood that such a memory component can comprise a plurality of physically discrete memory elements or can be comprised of a single memory element (as is suggested by the illustration).

This control circuit 108 can also operably couple to information sources as pertain to the aforementioned additional identifying information and characterizing information. Presuming for the sake of illustration that the aforementioned data message included a corresponding source telephone number, this additional identifying information source can comprise one or more reverse directory lookup databases 110 as are known in the art. The characterizing information source(s) in turn can comprise one or more characterizing information databases 111. The control circuit 108 can operably couple to these databases via direct connections where desired. More typically, however, an intervening network (such as the Internet) (not shown) may serve in these regards.

So configured, the control circuit 108 can be configured to carry out one or more of the steps, actions, or functions described herein. This can comprise, for example, configuring the control circuit 108 to use the source identifiers (as received in conjunction with the data messages 106 that are ultimately received by the communications interface 107) to determine additional identifying information for at least a substantial number of the end users, to use this additional identifying information to determine characterizing information for at least a substantial number of these end users, and to use that characterizing information to modify the common presentation (either directly or through cooperation with an external agent or agents).

As noted above, the actual modification or modifications to the presentation can be carried out, if desired, directly by the control circuit 108 itself. In this case, for example, the control circuit 108 can be operably coupled in some useful manner to affect, at least in part, some part of the presentation 101. As one simple example in this regard, the control circuit 108 can be configured to control the selection of particular promotional offerings to be rendered during the course of the presentation.

These teachings will also accommodate, however, facilitating the modification of the presentation 101 via some external enabler 112. This enabler 12 may itself comprise an automation of choice or can comprise, in whole or in part, a human agent. As one simple example in this regard, the enabler 112 can comprise a human announcer who recites a particular promotional offering as a part of the presentation 101 in response to the control circuit 108 having identified the particular promotional offering as per these teachings.

Those skilled in the art will recognize and understand that such an apparatus may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as is known in the art.

So configured, accurate and detailed characterizing information for a large number of persons who comprise a temporarily presently-available audience can be quickly developed without undue time or other requirements on the part of these persons. By developing this information quickly, a facilitator can use this characterizing information to develop uniquely targeted and relevant content (such as promotional content) for this audience while this audience in fact remains an “audience.” This characterizing information can be as detailed as one might wish and multiple resources can be consulted in these regards as desired. It will be especially appreciated that these benefits are attained in settings where a potentially vast audience is otherwise largely unknown a priori to the presenter and its agents.

Those skilled in the art will recognize and appreciate that these teachings are highly leveragable with numerous existing methodologies and resources. It will also be recognized that these teachings are scalable and will readily accommodate as small, or as large, an audience as might be wished.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in these regards, a real-time or near-real-time auction for promotional space/time can be conducted based upon the characterizing information amongst a pool of potential advertisers. Similar to an approach used by Google to auction search-results rankings amongst candidate hits, such an approach would permit advertisers to, essentially in real-time and on-the-fly, dynamically choose where, when, and how to acquire space/time for their targeted advertising to an audience that, heretofore, has not been amenable to such discretionary and selective targeting. As another example in these regards, it will be well understood and appreciated that the described steps of using the source identifier to determine additional identifying information and of using the additional identifying information to determine characterizing information can be combined into a single step if desired.

We claim:

1. A method comprising:
at a control circuit:
receiving a data message in conjunction with a corresponding source identifier from each of a plurality of sources, wherein the plurality of sources each have, at the time of sourcing their respective data message, a corresponding attending end user, wherein the end users are all presently sharing a common presentation;
using the source identifier to determine additional identifying information for at least a substantial number of the end users;
using the additional identifying information to determine characterizing information for at least a substantial number of the end users; at the control circuit or elsewhere:
using the characterizing information to modify the common presentation.

2. The method of claim 1 wherein the data message comprises a Short Message Service (SMS) data message sent in conjunction with the corresponding source identifier.

3. The method of claim 1 wherein the common presentation comprises a presentation at a presentation venue at which the end users are physically present.

4. The method of claim 1 wherein the common presentation comprises a broadcast presentation that the end users are each receiving.

5. The method of claim 1 wherein the source identifier comprises a 10 digit telephone number presently assigned to the corresponding source.

6. The method of claim 1 wherein the characterizing information comprises information regarding at least one of:
at least one category of demographic information;
at least one category of psychographic information; for the end users.

7. The method of claim 1 wherein using the source identifier to determine additional identifying information comprises using a telephone number as corresponds to each of the sources to query a reverse-directory lookup database.

8. The method of claim 1 wherein using the characterizing information to modify the common presentation comprises selecting at least one item of promotional content as a function, at least in part, of the characterizing information.

9. The method of claim 8 wherein selecting at least one item of promotional content comprises selecting the at least one item from amongst a plurality of candidate items of promotional content.

10. The method of claim 1 wherein using the characterizing information to modify the common presentation comprises customizing at least a portion of the presentation as a function, at least in part, of the characterizing information.

11. The method of claim 1 further comprising:
presenting, as a part of the presentation, an instruction to the end users to transmit the data messages.

12. The method of claim 11 wherein the instruction includes an incentive to motivate the end users to transmit the data messages.

13. An apparatus comprising:
a communication interface configured to receive a data message in conjunction with a corresponding source identifier from each of a plurality of sources, wherein the plurality of sources each have, at the time of sourcing their respective data message, a corresponding attending end user, wherein the end users are all presently sharing a common presentation;
a control circuit configured to:
use the source identifier to determine additional identifying information for at least a substantial number of the end users;
use the additional identifying information to determine characterizing information for at least a substantial number of the end users;
use the characterizing information to modify the common presentation.

14. The apparatus of claim 13 wherein the data message comprises a Short Message Service (SMS) data message sent in conjunction with the corresponding source identifier.

15. The apparatus of claim 13 wherein the common presentation comprises at least one of:
a presentation at a presentation venue at which the end users are physically present;
a broadcast presentation that the end users are each receiving.

16. The apparatus of claim 13 wherein the source identifier comprises a 10 digit telephone number presently assigned to the corresponding source.

17. A digital computer storage medium having stored therein computer instructions which, when executed by a digital computer, facilitate the digital computer:
receiving a data message in conjunction with a corresponding source identifier from each of a plurality of sources, wherein the plurality of sources each have, at the time of sourcing their respective data message, a corresponding attending end user, wherein the end users are all presently sharing a common presentation;
using the source identifier to determine additional identifying information for at least a substantial number of the end users;
using the additional identifying information to determine characterizing information for at least a substantial number of the end users; such that at least one of the digital computer and another enabler can use the characterizing information to modify the common presentation.

18. The digital computer storage medium of claim 17 wherein the data message comprises a Short Message Service (SMS) data message sent in conjunction with the corresponding source identifier.

19. The digital computer storage medium of claim 18 wherein the source identifier comprises a 10 digit telephone number presently assigned to the corresponding source.
